(19) United States
(12) Patent Application Publication
(10) Pub. No.: US 2011/0074912 A1
(43) Pub. Date: Mar. 31, 2011

(54) Providing an Indication of a Videoconference by a Videoconferencing Device

(76) Inventors: Wayne E. Mock, Round Rock, TX (US); Keith C. King, Austin, TX (US)

(21) Appl. No.: 12/889,961

(22) Filed: Sep. 24, 2010

Related U.S. Application Data
(60) Provisional application No. 61/246,348, filed on Sep. 28, 2009.

(51) Int. Cl. H04N 7/15

(52) U.S. Cl. 348/14.08; 348/E07.083

(57) ABSTRACT

Providing an indication of a videoconference. A videoconferencing device may include a processor and memory medium. The videoconferencing device may include one or more inputs for receiving audio and video of a videoconference. The videoconferencing device may also include one or more outputs for providing audio and video of the videoconference. At least one of the one or more outputs may be configured to connect to a display for displaying video signals from the videoconferencing device. The videoconferencing device may be configured to receive information indicating an incoming videoconference. However, when the information is received, the display may be providing display for a device other than the videoconferencing device. Accordingly, the videoconferencing device may be configured to provide an indication to a user of the incoming videoconference.

### PRIORITY DATA

This application claims benefit of priority of U.S. provisional application Ser. No. 61/246,348 titled “Providing an Indication of a Videoconference in a Videoconferencing Device” filed Sep. 28, 2009, whose inventors were Wayne E. Mock and Keith C. King, which is hereby incorporated by reference in its entirety as though fully and completely set forth herein.

### FIELD OF THE INVENTION

The present invention relates generally to conferencing and, more specifically, to a method for providing an indication of a videoconference.

### DESCRIPTION OF THE RELATED ART

Videoconferencing may be used to allow two or more participants at remote locations to communicate using both video and audio. Each participant location may include a videoconferencing system for video/audio communication with other participants. Each videoconferencing system may include a camera and microphone to collect video and audio from a first or local participant to send to other (remote) participant(s). Each videoconferencing system may also include a display and speaker(s) to reproduce video and audio received from one or more remote participants. Each videoconferencing system may also be coupled to (or comprise) a computer system to allow additional functionality into the videoconference. For example, additional functionality may include data conferencing (including displaying and/or modifying a document for both participants during the conference).

When a videoconferencing system is connected to a common audio/video output with multiple other devices, indications of an incoming videoconference may not be provided. Accordingly, improvements in conferencing systems are desired.

### SUMMARY OF THE INVENTION

Various embodiments are presented of a system and method for providing an indication of a videoconference.

A videoconferencing device may include a processor and memory medium. The videoconferencing device may include one or more inputs for receiving audio and video of a videoconference (e.g., a microphone, video camera, etc.). The videoconferencing device may also include one or more outputs for providing audio and video of the videoconference. At least one of the one or more outputs may be connected to a display for displaying video signals from the videoconferencing device.

The videoconferencing device may be configured to receive information indicating an incoming videoconference. For example, the videoconferencing device may receive a request to participate in a videoconference over a network. However, when the information is received, the display may be providing display for a device other than the videoconferencing device. Accordingly, the videoconferencing device may be configured to provide an indication to a user of the incoming videoconference.

In one embodiment, the videoconferencing device may be configured to provide an audible sound (e.g., using a “ringer”) to indicate an incoming videoconferencing call. Thus, even if the display device is displaying other content (such as TV or a movie), the user is still alerted as to the incoming videoconference.

### BRIEF DESCRIPTION OF THE DRAWINGS

A better understanding of the present invention may be obtained when the following detailed description is considered in conjunction with the following drawings, in which:

FIG. 1 and 2 illustrate exemplary videoconferencing system participant locations, according to an embodiment;

FIG. 3A and 3B illustrate exemplary conferencing systems coupled in different configurations, according to some embodiments; and

FIG. 4 is a flowchart diagram illustrating an exemplary method for providing an indication of a videoconference, according to an embodiment.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. Note that the headings are for organizational purposes only and are not meant to be used to limit or interpret the description or claims. Furthermore, note that the word “may” is used throughout this application in a permissive sense (i.e., having the potential to, being able to), not a mandatory sense (i.e., must). The term “include”, and derivations thereof, mean “including, but not limited to”. The term “coupled” means “directly or indirectly connected”.

### DETAILED DESCRIPTION OF THE EMBODIMENTS

### Incorporation by Reference

U.S. patent application titled “Video Conferencing System Transcoder”, Ser. No. 11/252,238, which was filed Oct. 17, 2005, whose inventors are Michael L. Kenoyer and Michael V. Jenkins, is hereby incorporated by reference in its entirety as though fully and completely set forth herein.

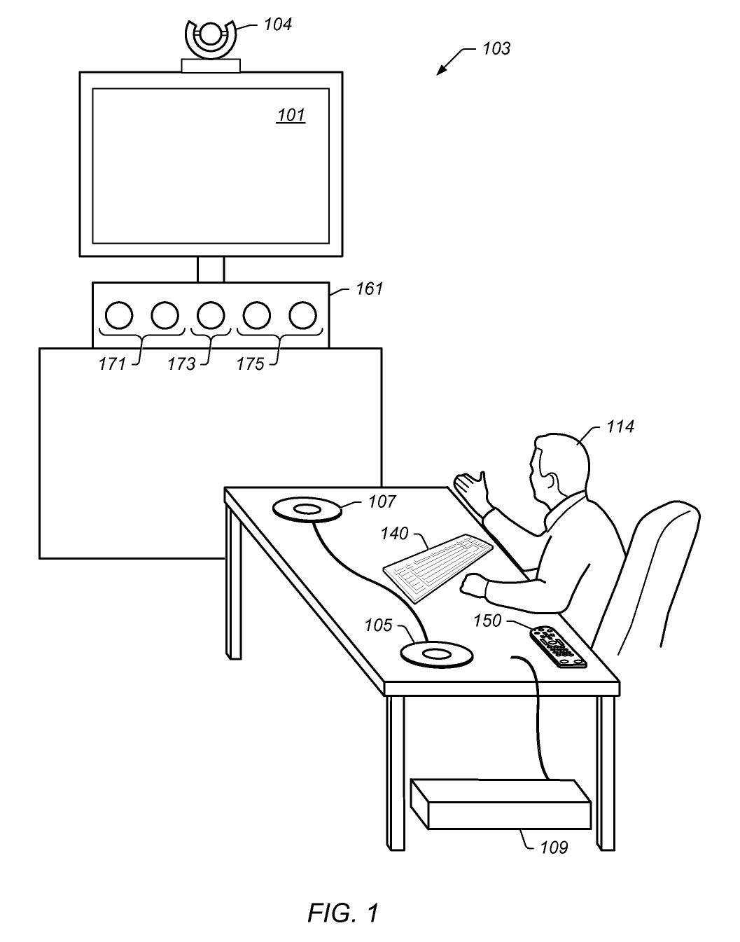

FIG. 1—Exemplary Participant Location

FIG. 1 illustrates an exemplary embodiment of a videoconferencing participant location, also referred to as a videoconferencing endpoint or videoconferencing system (or videoconferencing unit). The participant location of FIG. 1 may be in a conference room, a worker's office, a home office, etc. The videoconferencing system 103 may have a system codec 109 to manage both a speakerphone 105/107 and videoconferencing hardware, e.g., camera 104, display 101, speakers 171, 173, 175, etc. The speakerphones 105/107 and other videoconferencing system components may be coupled to the codec 109 and may receive audio and/or video signals from the system codec 109.

In some embodiments, the participant location may include camera 104 (e.g., an HD camera) for acquiring images (e.g., of participant 114) of the participant location. Other cameras are also contemplated. The participant location may also include display 101 (e.g., an HDTV display). Images acquired by the camera 104 may be displayed locally on the display 101 and/or may be encoded and transmitted to other participant locations in the videoconference.

The participant location may further include one or more input devices, such as the computer keyboard 140, a mouse, or a touch screen, such as a tablet (not shown). In some embodiments, the one or more input devices may be used for the videoconferencing system 103 and/or may be used for one or more other computer systems at the participant location, as desired.

The participant location may also include a sound system 161, which may be stereo, surround, etc. For example, in one embodiment, the sound system 161 may include multiple speakers including left speakers 171, center speaker 173, and right speakers 175. Other numbers of speakers and other speaker configurations may also be used. The videoconferencing system 103 may also use one or more speakerphones 105/107 which may be daisy chained together. Note that while the term “speakerphones” are used herein, microphones or other audio/video input devices may be used instead or in addition to speakerphones.

In some embodiments, the videoconferencing system components (e.g., the camera 104, display 101, sound system 161, and speakerphones 105/107) may be coupled to a system codec 109. The system codec 109 may be placed on a desk or on a floor, attached to the display 101, and/or embedded in the display 101. Similarly, the other videoconferencing components may be attached or embedded in the display 101, or other devices. The system codec 109 may receive audio and/or video data from a network, such as a LAN (local area network) or the Internet. The system codec 109 may send the audio to the speakerphone 105/107 and/or sound system 161 and the video to the display 101. The received video may be HD video that is displayed on the HD display. The system codec 109 may also receive video data from the camera 104 and audio data from the speakerphones 105/107 and transmit the video and/or audio data over the network to another conferencing system. The conferencing system may be controlled by a participant or user through the user input components (e.g., buttons) on the speakerphones 105/107 and/or input devices such as the keyboard 140 and/or the remote control 150. Other system interfaces may also be used.

In various embodiments, a codec may implement a real time transmission protocol. In some embodiments, a codec (which may be short for “compressor/decompressor”) may comprise any system and/or method for encoding and/or decoding (e.g., compressing and decompressing) data (e.g., audio and/or video data). For example, communication applications may use codecs for encoding video and audio for transmission across networks, including compression and packetization. Codecs may also be used to convert an analog signal to a digital signal for transmitting over various digital networks (e.g., network, PSTN, the Internet, etc.) and to convert a received digital signal to an analog signal. In various embodiments, codecs may be implemented in software, hardware, or a combination of both. Some codecs for computer video and/or audio may include MPEG, Indeo™, and Cinepak™, among others.

In some embodiments, the videoconferencing system 103 may be designed to operate with normal display or high definition (HD) display capabilities. The videoconferencing system 103 may operate with network infrastructures that support T1 capabilities or less, e.g., 1.5 mega-bits per second or less in one embodiment, and 2 mega-bits per second in other embodiments, although higher rates of transfer are envisioned.

Note that the videoconferencing system(s) described herein may be dedicated videoconferencing systems (i.e., whose purpose is to provide videoconferencing) or general purpose computers (e.g., IBM-compatible PC, Mac, etc.) executing videoconferencing software (e.g., a general purpose computer for using user applications, one of which performs videoconferencing). A dedicated videoconferencing system may be designed specifically for videoconferencing, and is not used as a general purpose computing platform; for example, the dedicated videoconferencing system may execute an operating system which may be typically streamlined (or “locked down”) to run one or more applications to provide videoconferencing, e.g., for a conference room of a company. In other embodiments, the videoconferencing system may be a general use computer (e.g., a typical computer system which may be used by the general public or a high end computer system used by corporations) which can execute a plurality of third party applications, one of which provides videoconferencing capabilities. Videoconferencing systems may be complex (such as the videoconferencing system shown in FIG. 1) or simple (e.g., a user computer system with a video camera, input devices, microphone and/or speakers). Thus, references to videoconferencing systems, endpoints, etc. herein may refer to general computer systems which execute videoconferencing applications or dedicated videoconferencing systems. Note further that references to the videoconferencing systems performing actions may refer to the videoconferencing application(s) executed by the videoconferencing systems performing the actions (i.e., being executed to perform the actions).

The videoconferencing system 103 may execute various videoconferencing application software that presents a graphical user interface (GUI) on the display 101. The GUI may be used to present an address book, contact list, list of previous callees (call list) and/or other information indicating other videoconferencing systems that the user may desire to call to conduct a videoconference.

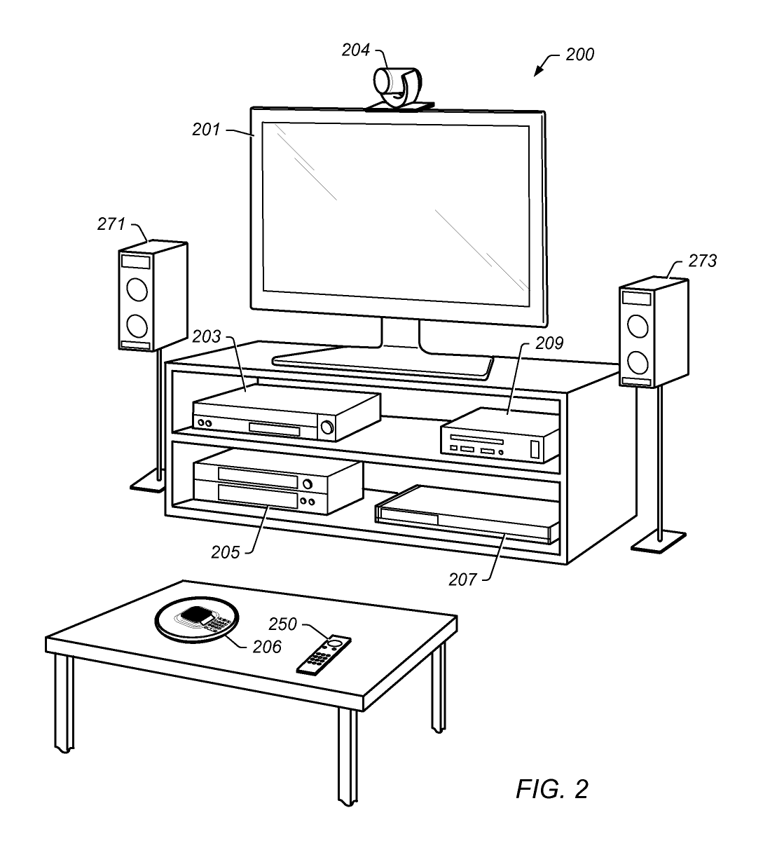

### FIG. 2—Exemplary Participant Location

FIG. 2 illustrates an alternate exemplary participant location, e.g., in the home of a participant. As shown in this location, the videoconferencing system 200 may include a codec 209, a display 201 (e.g., an LCD or plasma screen, such as for residential use), speakers 271 and 273, camera 204, speakerphone (or other audio input) 206, and input device (e.g., a remote) 250. The codec 209 may be coupled all or a subset of these devices. The codec may also be connected to a network, such as the Internet, e.g., in a wireless fashion.

As also shown, the display 201 may be connected to other devices, which may provide audio/video signals to the display 201. For example, the display 201 may be connected to a gaming console 203, a receiver 205, a DVD player 207, and/or other audio/visual devices. The receiver may receive audio from the various devices and provide the audio to the participant via the speakers 271 and 273. In some embodiments, audio and video may be provided to the display 201, e.g., from the codec 209, and the display 201 may provide audio to the receiver 205 for output via the speakers 271 and 273. Alternatively, the display 201 may only receive video, and audio may be provided directly to the receiver 205 from the various electronic devices, such as the codec 209. In further embodiments, all audio and video may be provided to the receiver 205, which may in turn route those signals out to respective output devices, such as the display 201 and the speakers 271 and 273.

At any particular time, the display 201 may provide video signals from one or more of the coupled electronic devices. As described below, in some instances, the codec 209 may receive an incoming videoconference while the display 201 and/or the receiver 205 are not actively providing the audio/video signals from the codec 209. Accordingly, as described herein, the codec 209 (or some other videoconferencing device) may provide (or otherwise cause) an indication of the incoming videoconference.

Note that the videoconferencing system shown in FIGS. 1 and 2 may be modified to be an audioconferencing system. The audioconferencing system, for example, may simply include speakerphones 105/107, although additional components may also be present. Additionally, note that any reference to a “conferencing system” or “conferencing systems” may refer to videoconferencing systems or audioconferencing systems (e.g., teleconferencing systems).

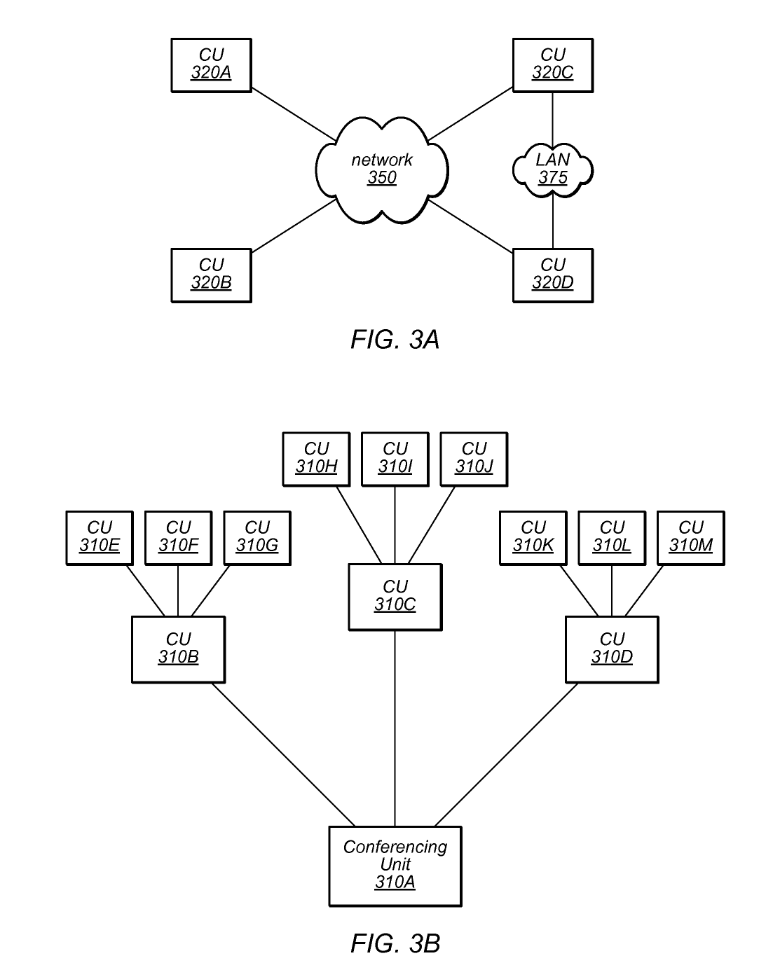

FIGS. 3A and 3B—Coupled Conferencing systems

FIGS. 3A and 3B illustrate different configurations of conferencing systems. The conferencing systems may be operable to perform the methods described herein. As shown in FIG. 3A, conferencing systems (CUs) 320A-D (e.g., videoconferencing systems 103 described above) may be connected via network 350 (e.g., a wide area network such as the Internet) and CU 320C and 320D may be coupled over a local area network (LAN) 375. The networks may be any type of network (e.g., wired or wireless) as desired.

FIG. 3B illustrates a relationship view of conferencing systems 310A-310M. As shown, conferencing system 310A may be aware of CU 310B-310D, each of which may be aware of further CU's (310E-310G, 310H-310J, and 310K-310M respectively). CU 310A may be operable to perform the methods described herein. In a similar manner, each of the other CUs shown in FIG. 3B, such as CU 310H, may be able to perform the methods described herein, as described in more detail below. Similar remarks apply to CUs 320A-D in FIG. 3A.

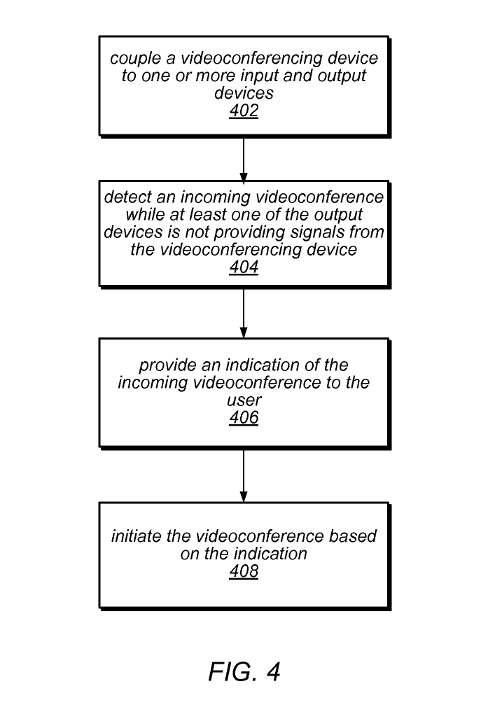

### FIG. 4—Providing an Indication of an Incoming Videoconference

FIG. 4 illustrates a method for providing an indication of an incoming videoconference. The method shown in FIG. 4 may be used in conjunction with any of the computer systems or devices shown in the above Figures, among other devices. In various embodiments, some of the method elements shown may be performed concurrently, performed in a different order than shown, or omitted. Additional method elements may also be performed as desired. As shown, this method may operate as follows.

In 402, a videoconferencing device may be coupled to one or more input and output devices, such as those shown and/or described with respect to FIGS. 1 and 2. More specifically, the videoconferencing device, e.g., a codec or control unit, may be coupled to various input devices, such as microphones, video cameras, etc., for receiving audio and video information of local participants for use in a videoconference. Additionally, the videoconferencing device may be coupled to various output devices, such as speakers, displays, etc. Note that one or more intermediary devices may be coupled between the videoconferencing device and the input or output devices (e.g., a receiver, a display, an audio/video selector, etc.). For example, audio and video signals may be provided to the receiver which may in turn provide audio output via speakers and video output via the display. Alternatively, the audio and video signals may be provided to the display, which may display the video signals and provide the audio to the receiver. In other embodiments, the videoconferencing device may simply provide the audio and video signals to the corresponding devices, e.g., audio to the receiver and video to the display.

The videoconferencing device and display may be at an office building, e.g., a conference room or office room, or at a home of a participant, as desired. The types of devices coupled to the display may vary accordingly, depending on the location of the videoconferencing device and display. For example, at an office, the display may be coupled to the videoconferencing device and a computer system, whereas at a home, the display may be coupled to a gaming console, a DVD player, a cable box, etc.

The display coupled to the videoconferencing device may be initially displaying signals from an input source that is different from the videoconferencing device. For example, the display may be displaying video signals from an input source such as a gaming console, a cable or broadcast TV device, a DVD player, a separate computer system, etc. Thus, the display coupled to the videoconferencing device may not be displaying video signals provided by the videoconferencing device, e.g., even when the videoconferencing device is powered on and/or actively providing video signals to the display. Accordingly, the receiver and/or other audio providing device (e.g., possibly even the display itself) may provide audio signals corresponding to the video signals currently displayed by the display. These audio signals may be provided by the source device (e.g., the gaming console, DVD player, etc.) or may be provided via the display, e.g., in an indirect manner from the source device. Regardless, the audio signals of the videoconferencing device may not be provided as output, initially. Thus, at an initial point in time, the video and/or audio signals of the videoconferencing device may not be provided as output, e.g., via the display.

In 404, an incoming videoconferencing call may be detected, e.g., by the videoconferencing device. For example, the videoconferencing device may receive information indicating an incoming videoconference, e.g., over a local or wide area network, such as the Internet. As indicated above, when the incoming videoconferencing call is detected or otherwise received, the video and/or audio signals of the videoconferencing device may not be provided as output, e.g., via the display.

Accordingly, in 406, the videoconferencing device may provide an indication to a user of the incoming videoconference. The indication may be provided to the user via a variety of mechanisms. In one embodiment, the videoconferencing device may be capable of providing its own independent (e.g., of the receiver or other audio producing device) audible indication of the incoming videoconference. For example, the videoconferencing device may include a “ringer” or audio producing device which provides a “ring” for indicating an incoming videoconferencing device. The ringer may be an internal speaker of the videoconferencing device, which may provide various audible indications, such as a telephone ring or ring tone, among other possibilities. However, the videoconferencing device may be configured to provide the indication via external audio devices, e.g., the receiver or another audio system, such as a home alarm system.

Alternatively, or additionally, the videoconferencing device may be able to provide visual indications of the incoming videoconference. For example, the videoconferencing device may include one or more lights which may be used to provide the indication. More specifically, in one embodiment, a light which is normally off may turn on, or the light (e.g., which is already on or off, as desired) may begin to blink. In further embodiments, where there are a plurality of lights, various patterns may be displayed to the user, e.g., for indicating various different types of incoming videoconferencing calls.

However, it should be noted that other methods of providing indications are envisioned. For example, in some embodiments, the videoconferencing device may be able to provide an indication to the display which indicates that the display should switch to displaying video signals from the videoconferencing device, e.g., in an automatic fashion. For example, the videoconferencing device may be able to send a signal which the display detects as “new” video signals, thereby initiating a source detection mechanism of the display to initiate a switching procedure. In one particular embodiment, the videoconferencing device may be able to enable this behavior by sending a specific type of signal, or by halting sending of video signals to the display for a specific time period (thereby allowing the display to detect the incoming video signals as “new”). In some embodiments, the videoconferencing device may be able to particularly effect such behavior by ceasing to send video signals when no user input is received for a specific time period (e.g., 1 minute, 5 minutes, 10 minutes, etc.).

Similarly, the videoconferencing device may send signals to an audio device (which may still be the display, but may be another device, such as a receiver) to mimic the same behavior as above, except with audio. Thus, the videoconferencing device may be able to cause an audio producing device to switch to providing audio signals of the videoconferencing device and then provide an audible indication of the incoming videoconference via the audio producing device.

In further embodiments, the videoconferencing device may be able to send an indication to the display to provide a message to the user via the display device. For example, while the user is viewing content from another video device (e.g., from a cable provider), the videoconferencing device may provide a message to the user via the device. The message may be overlaid on to the video content of the other device, thereby notifying the user of the incoming videoconference without actively switching the input source of the display. Such behavior may be enabled by an API or other interface with the display which allows the videoconferencing device to provide messages on the display. For example, the videoconferencing device may provide a specific type of signal, e.g., where the signal includes a certain header or other information, which indicates that content of the signal should be provided as an indication on the display even when the display is not actively providing video signals from the videoconferencing device. Correspondingly, the user may be made aware of the signal by viewing an indication on the display even while watching video signals from other device(s). Similarly, such messages may be transmitted by the videoconferencing device to an audio device, such as a receiver, e.g., in a similar fashion. The audio device may then provide audible indication(s) of the incoming videoconference based on the message(s).

In some embodiments, the videoconferencing device may also be in communication with other devices, e.g., associated with the user. For example, the videoconferencing device may be in communication with a mobile device of the user, such as a portable computer (e.g., a tablet, laptop, etc.), cellular phone, or personal digital assistant (PDA). The videoconferencing device may be coupled to the mobile device in a wireless fashion (e.g., using 802.11x, Bluetooth, WiMax, etc.) or in a wired fashion, as desired. The videoconferencing device may then provide messages to the user via the mobile device. For example, the videoconferencing device may provide an indication to the mobile device, which may then provide one or more audible or visual indications to the user. For example, the user's mobile device may ring when an incoming videoconference is detected. Alternatively, or additionally, the mobile device may display a message, such as a pop-up message, to the user to indicate the incoming videoconference. Thus, in some embodiments, a portable or mobile device may convey (or be) an indication of the incoming videoconference to the user.

In some embodiments, the videoconferencing device may be coupled to other devices to provide indications to the user, e.g., an alarm system of the user's home, or any other electronic device capable of providing indications to the user, such as the remote control that controls the display and/or receiver. For example, where the videoconferencing device is coupled to lights or a home system controlling the home of the user, the lights may be dimmed or may blink upon detecting an incoming videoconference, although other methods of indications are envisioned.

Note that any or all of the above described methods for providing the indication may be implemented or used when an incoming videoconference is detected. Additionally, various ones of the indications described above may be modified to indicate the type of videoconference that is being received and/or additional information, such as the other participants of the incoming videoconference. Such information may be provided in an audio or visual manner, as desired. For example, the audio of an audible indication may have a specific ring tone or sound for certain participants or groups of participants. Alternatively, or additionally, the audible indication may simply speak the indication and/or the names of the participants. Further, any video indication may include a list of participants of the videoconference. Additionally, further methods of indication are envisioned.

In 408, the output of the display may be switched from providing video from an original source device to providing video from the videoconferencing device. Similarly, the audio output device (e.g., the receiver) may be switched from providing audio from the original source device to the audio of the videoconferencing device. Thus, in response to the indication of the incoming videoconference, the audio and/or video of the videoconferencing device may be provided to the user at a second point in time, instead of the audio and/or video of the original source device at the initial time. Note that this switching may be performed manually by the user, where the user specifically instructs the display and/or receiver to switch to providing output from the videoconferencing device, or automatically, where the display and/or receiver switch to providing output from the videoconferencing device without the user providing that instruction. This automatic operation may occur where the videoconferencing device implements various features described above, among others, which may be used to cause a switching event by the display and/or receiver (or other controlling device).

In 410, the videoconference may be initiated between a plurality of participants at respective participant locations based on the incoming videoconference call. The videoconference may be initiated in response to user input, or automatically, in response to the detection of the videoconference, as desired. The videoconference may be established according to any of a variety of methods, e.g., the one described in patent application Ser. No. 11/252,238, which was incorporated by reference above. The videoconference may utilize an instant messaging service or videoconferencing service over the Internet, as desired.

Note that the methods described herein may also apply to audioconferences, e.g., where an audio producing device is not actively providing audio signals from an audioconferencing device.

### Further Embodiments

In further embodiments, the codec or videoconferencing device may be interposed between a source device and the display. Thus, the codec may provide the signals of the source device to the display, e.g., in a manner where the user could not tell the codec was doing so. In this case, when a videoconferencing call is received or detected, the videoconferencing device can provide an indication of the incoming videoconference call by modifying the signals of the source device or changing them completely. For example, the videoconferencing device may add a visual overlay over the video signals of the source device or add an audible indication (e.g., a ring) to the audio signals of the source device. In further embodiments, the source device signals may be interrupted or stopped from being displayed when the videoconference call is detected. Thus, an indication of the videoconference may be provided to the user even when viewing and/or listening to signals from a source device instead of the videoconferencing device.

In another embodiment, the videoconferencing device may be incorporated into the display and/or receiver (or a signal controller that controls flow of signals in the audio video system). For example, the display may provide codec functionality for a videoconference, e.g., using internal videoconferencing circuitry. In this case, upon detection of an incoming videoconference, the display may simply provide a visual or audio indication of the incoming videoconference, e.g., according to any of the methods described herein. In this embodiment, no signals may have to be provided to the display since the videoconferencing device is incorporated into the display.

### Advantages

The method described above has substantial advantages over prior methods. Typically, in prior conferencing systems, a user would have to actively monitor a videoconferencing device to notice an incoming videoconference. Thus, it was not possible to actively watch or listen to another device and still be made aware of an incoming videoconference. However, by providing indications in an independent manner, the videoconferencing device is able to notify a user who is not actively monitoring the videoconferencing device's audio or video signals.

Embodiments of a subset or all (and portions or all) of the above may be implemented by program instructions stored in a memory medium or carrier medium and executed by a processor. A memory medium may include any of various types of memory devices or storage devices. The term “memory medium” is intended to include an installation medium, e.g., a Compact Disc Read Only Memory (CD-ROM), floppy disks, or tape device; a computer system memory or random access memory such as Dynamic Random Access Memory (DRAM), Double Data Rate Random Access Memory (DDR RAM), Static Random Access Memory (SRAM), Extended Data Out Random Access Memory (EDO RAM), Rambus Random Access Memory (RAM), etc.; or a non-volatile memory such as a magnetic media, e.g., a hard drive, or optical storage. The memory medium may comprise other types of memory as well, or combinations thereof. In addition, the memory medium may be located in a first computer in which the programs are executed, or may be located in a second different computer that connects to the first computer over a network, such as the Internet. In the latter instance, the second computer may provide program instructions to the first computer for execution. The term “memory medium” may include two or more memory mediums that may reside in different locations, e.g., in different computers that are connected over a network.

In some embodiments, a computer system at a respective participant location may include a memory medium(s) on which one or more computer programs or software components according to one embodiment of the present invention may be stored. For example, the memory medium may store one or more programs that are executable to perform the methods described herein. The memory medium may also store operating system software, as well as other software for operation of the computer system.

Further modifications and alternative embodiments of various aspects of the invention may be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A videoconferencing device, comprising:
a processor;
one or more inputs for receiving audio and video of a videoconference;
one or more outputs for providing audio and video of the videoconference, wherein at least one of the one or more outputs is configured to connect to a display for displaying video signals from the videoconferencing device;
a memory medium coupled to the processor, wherein the memory medium stores program instructions executable by the processor to implement:
receiving information indicating an incoming videoconference, wherein, when the information is received, the display is providing display for a device other than the videoconferencing device; and
providing an indication to a user of the incoming videoconference.

2. The videoconferencing device of claim 1, further comprising:
an audible indicator;
wherein said providing the indication to the user comprises providing the indication audibly via the audible indicator.

3. The videoconferencing device of claim 2, wherein the audible indicator comprises a ringer.

4. The videoconferencing device of claim 1, wherein said providing the indication to the user comprises providing a signal to the display to provide the indication to the user.

5. The videoconferencing device of claim 4, wherein the signal causes the display to display video signals of the videoconferencing device.

6. The videoconferencing device of claim 4, wherein the signal causes the display to provide a visual indication of the incoming videoconference.

7. The videoconferencing device of claim 4, wherein the signal causes the display to provide an audible indication of the incoming videoconference.

8. The videoconferencing device of claim 1, wherein the videoconferencing device interposed between the device other than the videoconferencing device and the display, wherein the videoconferencing device is configured to receive video signals for the device other than the videoconferencing device and provide those video signals to the display, wherein said providing an indication to the user of the incoming videoconference interrupts the video signals from the device other than the videoconferencing device.

9. The videoconferencing device of claim 1, wherein said providing the indication to the user comprises providing the indication to a mobile device of the user, wherein the mobile device is configured to provide a corresponding indication to the user.

10. The videoconferencing device of claim 1, wherein said providing the indication to the user comprises providing the indication to a receiver, wherein the receiver is configured to provide the indication to the user.

11. A method, comprising:
receiving, by a videoconferencing device, information indicating an incoming videoconference, wherein the videoconferencing device is coupled to a display for displaying video signals of a videoconferencing device, and wherein, when the information is received, the display is providing display for a device other than the videoconferencing device; and
providing an indication to a user of the incoming videoconference.

12. The method of claim 11, wherein said providing the indication to the user comprises providing the indication audibly via an audible indicator of the videoconferencing device.

13. The method of claim 12, wherein the audible indicator comprises a ringer.

14. The method of claim 11, wherein said providing the indication to the user comprises providing a signal to the display to provide the indication to the user.

15. The method of claim 14, wherein the signal causes the display to display video signals of the videoconferencing device.

16. The method of claim 14, wherein the signal causes the display to provide a visual indication of the incoming videoconference.

17. The method of claim 14, wherein the signal causes the display to provide an audible indication of the incoming videoconference.

18. The method of claim 11, wherein the videoconferencing device interposed between the device other than the videoconferencing device and the display, wherein the method further comprises:
receiving video signals for the device other than the videoconferencing device; and
providing those video signals to the display;
wherein said providing an indication to the user of the incoming videoconference interrupts the video signals from the device other than the videoconferencing device.

19. The method of claim 11, wherein said providing the indication to the user comprises providing the indication to a mobile device of the user, wherein the mobile device is configured to provide a corresponding indication to the user.

20. The method of claim 11, wherein said providing the indication to the user comprises providing the indication to a receiver, wherein the receiver is configured to provide the indication to the user.
